(19) United States
(12) Patent Application Publication
(10) Pub. No.: US 2018/0043769 A1
(43) Pub. Date: Feb. 15, 2018

(54) Fuel tank

(71) Applicant: Rausteel Oy, Ylikiiminki (FI)

(72) Inventor: Samu Rautiainen, Ylikiiminki (FI)

(73) Assignee: Rausteel Oy, Ylikiiminki (FI)

(21) Appl. No.: 15/559,549

(22) PCT Filed: Feb. 11, 2016
(86) PCT No.: PCT/FI2016/050086

§ 371 Date: Sep. 19, 2017

(30) Foreign Application Priority Data
Mar. 20, 2015 (FI) U20154056

(51) Int. Cl. B60K 15/05; B60K 15/04

(52) U.S. Cl. CPC B60K 15/05; B60K 15/0409; B60K 2015/0523; B60K 2015/03434

(57) ABSTRACT

The fuel tank of a vehicle has a wail (26) and filling pipe (10) for adding fuel. The filling pipe has a mouth, through which there opens a connection into the fuel tank, The fuel tank comprises a protective cover (16) installed movably to the wall, the protective cover being movable to a first position in front of the mouth of the filling pipe and to a second position away from the front of the mouth of the filling pipe. The mouth of the filling pipe is usually covered by a releasable cap (14). When the protective cover is in front of the mouth, the cap in the mouth cannot be accessed and it cannot be removed from the end of the filling pipe. Respectively, when the protective cover is in the second position, it does not prevent or hinder the handling of the cap at the end of the filling pipe. The fuel tank can further comprise a locking element for locking the protective cover in place to the said first position. Preferably the locking element can be opened from the cabin of the vehicle.

The invention relates to a fuel tank of a vehicle, with a wall and filling pipe for adding fuel, the filling pipe having a mouth.

Vehicles provided with large fuel tanks, such as lorries and trucks, are often subject to fuel thefts and/or vandalism. The size of a vehicle's fuel tank can be several hundreds of litres, so losing the entire content of the tank to a thief causes a big financial loss to the owner of the vehicle. Fuel is stolen from the fuel tank most often through the fuel filling pipe or through the fuel suction pipe leading from the tank to the motor of the vehicle. A hole can also easily be punctured to the wall of a fuel tank made of plastic or thin metal sheet, through which the tank can be drained empty.

For preventing thefts, locked caps and grates riveted to the filling pipe of the fuel tank are used in vehicle fuel tanks. A locked cap is usually made of plastic, which makes the cap or its lock section is easy to break. Retrofitted grates are usually attached in place by rivets so that they are easily removable. In current fuel tanks, it is in practice not possible to prevent the puncturing of a fuel tank wall or breaking of a suction pipe in any way.

The object of the invention is to introduce a fuel tank, with which it is possible to make stealing of fuel from the tank significantly more difficult. The objects of the invention are achieved with a fuel tank, which is characterised in what is disclosed in the independent claims. Some advantageous embodiments of the invention are disclosed in the dependent claims.

The object of the invention is a fuel tank of a vehicle, which has a wall and a filling pipe for adding fuel. The filling pipe has a mouth, through which there opens a connection into the fuel tank. The fuel tank comprises a protective cover attached movably to the wall, the protective cover being movable to a first position in front of the filling pipe mouth and to a second position away from the front of the filling pipe mouth. Preferably the fuel tank comprises slide elements, such as slide rods, on which the protective cover is arranged to move between the first and second position. The mouth of the filling pipe is usually covered by a releasable cap. When the protective over is in front of the mouth, it is not possible to access the cap in the mouth and it cannot be removed from the end of the filling pipe. Steeling fuel through the filling pipe is thus impossible, when the protective cover is in the first position. Respectively, when the protective cover is in the second position, it does not prevent or hinder the handling of the cap at the end of the filling pipe. The cap can then be removed from the front of the mouth in a conventional manner for adding the fuel and attached back in place after the fuel has been added.

An advantageous embodiment of the fuel tank of the invention comprises further a locking element for locking the protective cover in place to said first position. Because of the locking element the protective cover can only be opened by a person who is capable to open the locking element. Preferably the locking element can be opened from the cabin of the vehicle. In this case, opening the locking element requires access to the cabin of the vehicle, i.e. the person opening the locking has to have keys to the cabin of the vehicle. Because being able to access the cabin already requires the possession and use of the keys of the vehicle, opening the locking element from the cabin can be arranged to occur without a separate key.

In a second advantageous embodiment of the fuel tank of the invention said locking element comprises a lock cylinder, which has a locking pin moving in and out, and the protective cover has a locking hole for receiving the locking pin. When the locking pin of the lock cylinder has been moved into the locking hole of the protective cover, the protective cover is not able to move.

In a third advantageous embodiment of the invention said lock cylinder is connectable to the pneumatic system of the vehicle and the locking pin is arranged to set into a locking position preventing the moving of the protective cover, as the air pressure in the lock cylinder is lower than the set relief pressure. In the locking position, the locking pin is placed into the locking hole in the protective cover, thus preventing the protective cover from moving. The locking pin sets to the locking position, when the pressure in the vehicle's pneumatic system is sufficiently low. Preferably the locking pin of the lock cylinder is arranged to move to a release position allowing the protective cover to move, as the pressure in the lock cylinder is higher than the set relief pressure. In the release position the locking pin moves away from the hole of the protective cover and does not prevent the moving of the protective cover. Moving the locking pin from the locking position to the release position requires that the pressure in the vehicle's pneumatic system is sufficiently high.

Yet another advantageous embodiment of the fuel tank of the invention comprises a protective casing, into which the lock cylinder is fitted. The protective casing prevents the opening of the locking of the protective cover by force by breaking the lock cylinder.

Yet another advantageous embodiment of the fuel tank of the invention further comprises a suction pipe for leading fuel out from the fuel tank. The suction pipe is arranged at least partly inside a protective casing so that the protective casing prevents the suction pipe from being detached or cut.

In yet another advantageous embodiment of the fuel tank of the invention the wall, filling pipe, protective cover and protective casing are made of steel, preferably durable special steel. Fuel tank parts made of steel endure well mechanical stress, so puncturing the wall of the fuel tank or breaking the parts protecting the filling pipe is difficult.

It is an advantage of the invention that it makes the stealing of fuel from the fuel tank significantly more difficult. Thus the invention brings the vehicle owners savings in fuel costs.

Further, the invention improves traffic safety and shortens transport times, because fuel thefts do not slow down the operation of the vehicle.

It is further an advantage of the invention that it protects the environment by preventing fuel from leaking to the environment, caused by fuel thefts.

The invention is next explained in more detail, referring to the attached drawings, in which

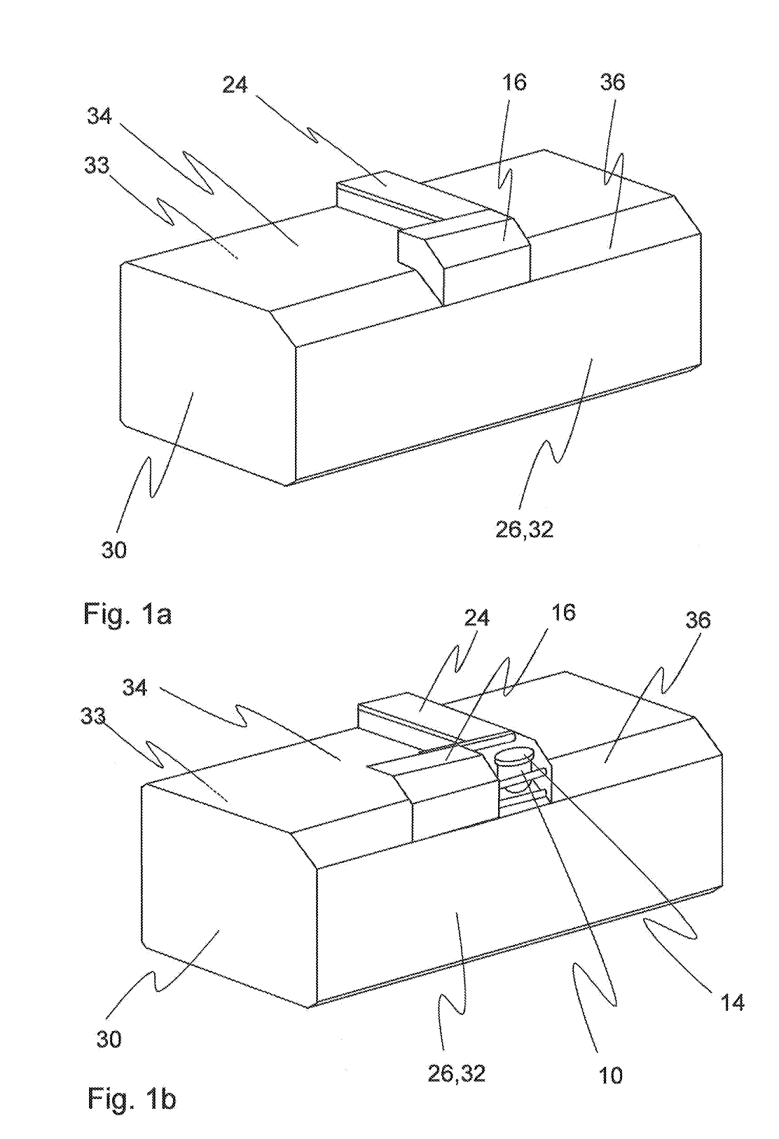

FIGS. 1a and 1b illustrate in an exemplary manner a fuel tank of the invention, seen obliquely from the front, and

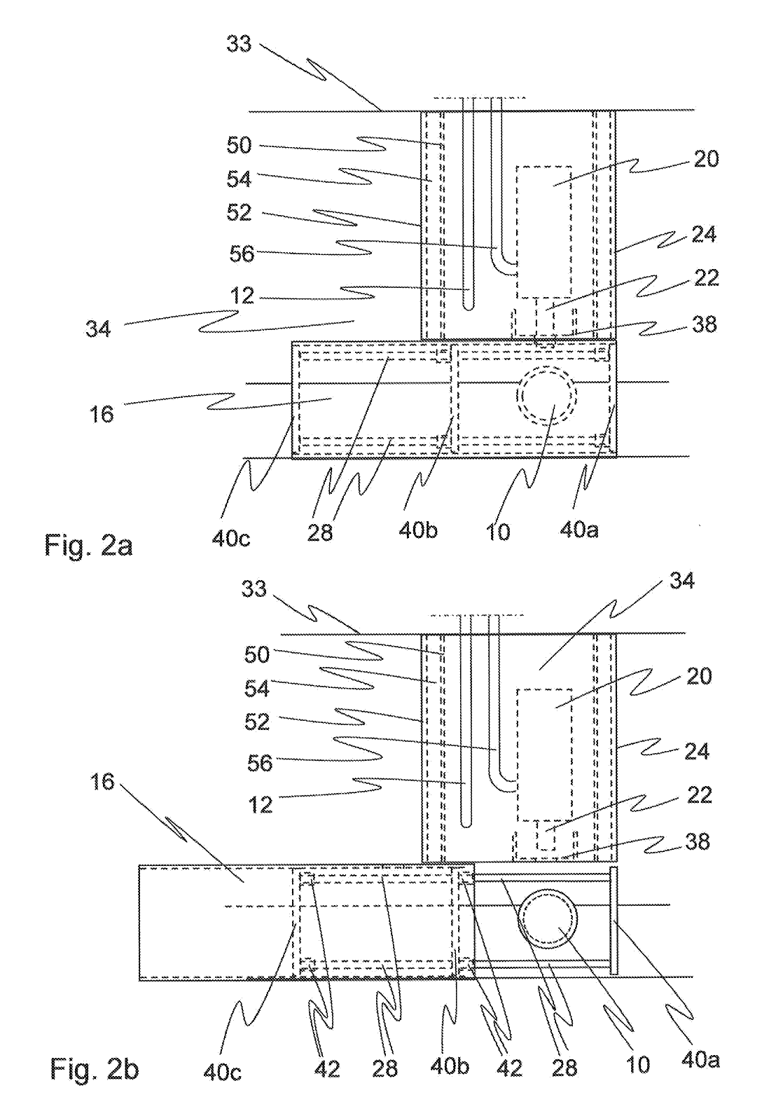

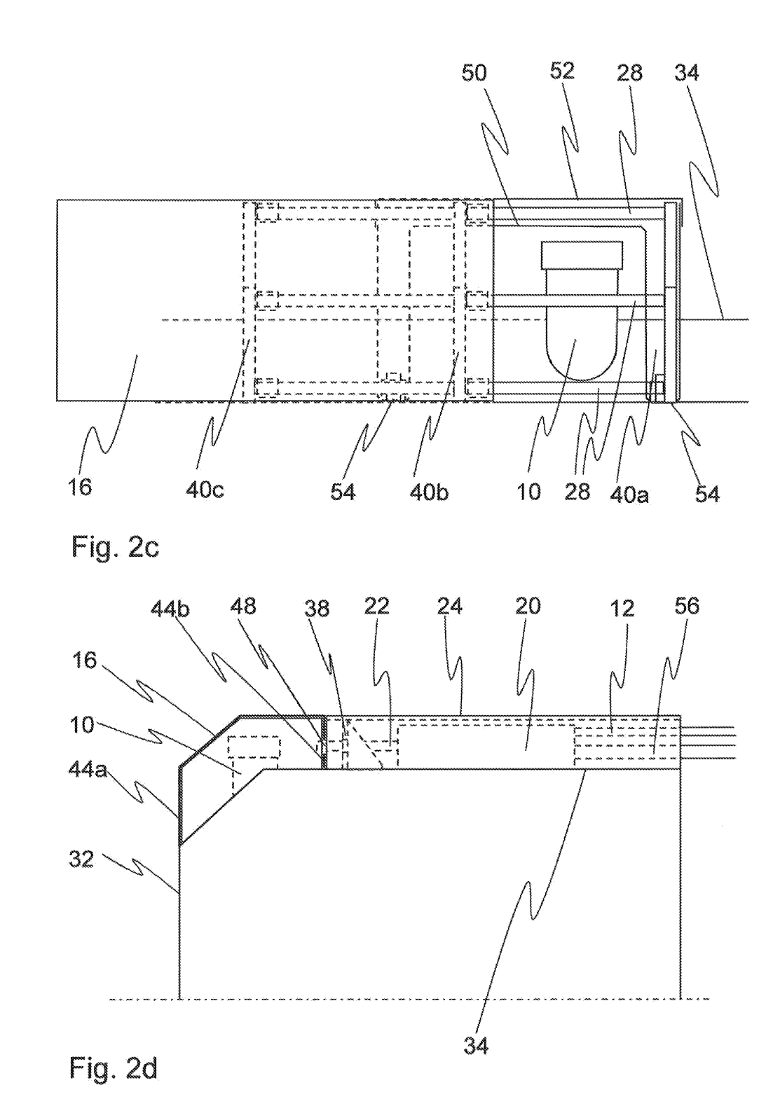

FIGS. 2a-2d illustrate in an exemplary manner a part of a fuel tank of the invention, seen from different directions.

In FIGS. 1a and 1b there is illustrated in an exemplary manner a fuel tank of the invention, seen obliquely from the front and above. The fuel tank is an elongated enclosed tank, which has a liquid-proof wall 26 made of steel plate. The wall has two end walls 30 and a tubular side wall between them. The side wall comprises a front side 32, back side 33, bottom and lid 34. The bottom, the back side and the second end wall remain invisible in FIGS. 1a and 1b. In the edge of the lid 34 joining to the front side there is an edge strip 36, which bends to an angle from the plane of the lid. FIGS. 1a and 1b illustrate the fuel tank substantially in the position, in which it is designed to be attached to a vehicle (the vehicle is not shown in the figures). In this case, the lid 34 of the wall forms the uppermost surface of the fuel tank wall 26.

In the lid 34 of the wall 26 there is provided a filling pipe 10, through which there opens a connection through the wall into the fuel tank. The filling pipe has a mouth, which is covered by an openable cap 14 (FIG. 1b). The lid further has a protective cover 16 and a protective casing 24. The protective cover is attached to the lid so that it can be moved to a first position, in which it is in front of the filling pipe mouth (FIG. 1a) and to a second position, in which it has moved away from the front of the filling pipe mouth (FIG. 1b). The protective cover in the first position prevents the release of the cap 14 covering the mouth of the filling pipe 10 so that it is impossible to remove fuel from the tank through the filling pipe. When the protective cover is in the second position, the cap of the filling pipe can be opened and closed in a normal manner, which makes it possible to add fuel into the tank. The lid 34 of the fuel tank further has a protective casing 24 with a rectangular cross-sectional shape, extending on the upper surface of the lid from the edge of the protective cover 16 to the back side 33 of the fuel tank.

In FIGS. 2a and 2b there is illustrated a part of the fuel tank seen from the top, above the lid 34, and in FIG. 2c from the side, from the direction of the front side 32. The parts remaining below the protective cover 16 and the protective casing 24 are drawn with broken lines. Said figures are next explained simultaneously.

The protective casing is a trough-type part opening towards the lid 34 of the fuel tank, which has an inner wall 50 and outer wall 52, and a neck 54 (FIG. 2c) connecting the said walls and setting against the surface of the lid 34. The outer wall can consist of several parts. The protective casing is attached to the lid with bolts, which are welded from their first ends to the lid 34, and the second ends of which extend through the holes in the neck 54 between the inner wall and outer wall. To the upper surface of the lid, to a space outlined by the inner wall 50 of the protective casing 24 and the lid 34 there is attached a lock cylinder 20 with a protruding locking pin 22. The lock cylinder is a pneumatic cylinder, which can be connected to the vehicle's pneumatic system with pneumatic hoses 56. Inside the lock cylinder there is a spring, which forces the locking pin to a protruding locking position according to FIG. 2a, when the air pressure in the cylinder is lower than the propulsive force of the spring. When the air pressure in the cylinder grows bigger than the propulsive force of the spring, the locking pin 22 moves towards the interior of the lock cylinder to the opening position according to FIG. 2b. Inside the protective casing, at the end abutting the protective cover of the protective casing there is further a locking plate 38, which is attached to the lid 34 with a weld mounting. The locking plate is placed to the path of the locking pin 22, and it has a hole which is slightly bigger than the diameter of the locking pin, through which the locking pin moving to the locking position can travel. Inside the protective casing there is further a fuel suction pipe 12, the first end of which extends through a hole in the lid into the fuel tank. The second end of the suction pipe extends through the second open end of the protective casing 24 outside the protective casing.

Below the protective cover 16 there are three polygon-shaped support plates 40a, 40b, 40c attached to the upper surface of the lid 34 by welding. The first support plate 40a is attached to the edge of the lid substantially in the same line with the second longitudinal edge of the protective casing 24. The third support plate 40c is attached in the same way to the edge of the lid at a distance of the length of the protective cover from the first support plate, and the second support plate 40b is attached to the lid substantially halfway of the first and second support plate. The filling pipe 10 of the fuel tank is located between the first and second support plate. The first and second support plate and the second and third support plate are connected to each other with three slide bars 28 of a circular cross-section (FIG. 2c). Around each slide bar there is a short tubular sliding sleeve 42. The sliding sleeves in the slide bars 28 between the first and second support plate are attached to the surface facing the fuel tank of the protective cover close to the first end of the protective cover. The sliding sleeves in the slide bars between the second and third support plate are attached by welding to the surface of the protective cover facing the fuel tank substantially halfway of the length of the protective cover. The slide bars and sliding sleeves form sliding elements, on which the protective cover can be moved in the longitudinal direction of the slide bars between the first position shown in FIG. 2a and the second position shown in FIG. 2b. When the protective cover 16 is in the first position according to FIG. 2a, the protective cover, the first support plate 40a and the second support plate 40b define a substantially closed space on the upper surface of the lid, inside which the mouth of the filling pipe 10 is located.

In FIG. 2d there is shown in an exemplary manner the part of the fuel tank shown in FIGS. 2a, 2b and 2c, seen from the side, from the direction of the second end wall. The parts remaining below or behind the protective cover 16 and the protective casing 24 are drawn with broken lines. The protective cover is a trough-type part opening downwards, which has a first edge side 44a substantially on the same plane with the front side 32, a second edge side 44b substantially parallel with the first edge, and a middle section between the first and second edge side. The free edges of the edge sides extend very close to, preferably about a millimeter from the surface of the fuel tank lid 34. In the second edge side there is a thorough locking hole 48, which sets on the same line with the locking pin 22 of the lock cylinder 20 and the hole in the locking plate 38, when the protective cover 16 is in the first position according to FIG. 2a. In the locking position the end of the locking pin 22 extends through the hole of the locking plate 38 and the locking hole 48 of the second edge side 44b, thus preventing the moving of the protective cover in the direction of the slide bars 28.

The first end of the protective casing 24 extends to be nearly in contact with the second edge side 44b of the protective cover 16, and the open second end of the protective casing extends up to the back side 33 of the fuel tank. In a fuel tank installed in place to the vehicle, the second end of the protective casing is located very close to the vehicle body so that the protective casing is in practice closed also from its second end. Upon leaving the protective casing, the fuel suction pipe 12 leading from the protective casing to the vehicle's motor travels protected by the vehicle's body structures.

The lock cylinder 20 is connected to the vehicle's pneumatic system by pneumatic hoses 56. In a fuel tank installed in place to the vehicle, also the pneumatic hoses travel in the protection of the vehicle's body structures immediately when leaving the protective casing. Thus it is in practice very difficult to access the pneumatic hoses, the suction pipe of the fuel tank or the lock cylinder inside the protective casing, so that they are protected against thieves and vandalizers. A control device for the lock cylinder can be arranged into the locked cabin of the vehicle so that it can only be used by a person in possession of the keys to the vehicle's cabin.

Some advantageous embodiments of the fuel tank of the invention have been explained above. The invention is not restricted to the solutions disclosed above, but the inventional idea can be applied in different ways within the limits set by the patent claims.

1. Fuel tank of a vehicle, which has a wall (26) and filling pipe (10) for adding fuel, the filling pipe (10) having a mouth, characterized in that the fuel tank comprises a protective cover (16) movably attached to the wall (26), which protective cover is movable to a first position in front of the mouth of the filling pipe (10) and to a second position away from the front of the mouth of the filling pipe (10).

2. Fuel tank according to claim 1, characterized in that it comprises sliding elements, such as slide bars (28), on which the protective cover (16) is arranged to move between the first and second position.

3. Fuel tank according to claim 1 or 2, characterized in that it further comprises a locking element for locking the protective cover (16) in place to said first position.

4. Fuel tank according to claim 3, characterized in that said locking element can be opened from the cabin of the vehicle.

5. Fuel tank according to claim 3 or 4, characterized in that said locking element comprises a lock cylinder (20), which has a locking pin (22) moving in and out, the protective cover having a locking hole (48) for receiving the locking pin (22).

6. Fuel tank according to claim 5, characterized in that the said lock cylinder (20) is connectable to the pneumatic system of the vehicle and that the locking pin (22) is arranged to be set to a locking position preventing the moving of the protective cover (16), when the air pressure in the lock cylinder (20) is lower than the set relief pressure.

7. Fuel tank according to claim 6, characterized in that the locking pin (22) of the lock cylinder (20) is arranged to move to an opening position releasing the moving of the protective cover (16), when the air pressure in the lock cylinder (20) is higher than the set relief pressure.

8. Fuel tank according to any of the claims 1-7, characterized in that the fuel tank comprises a protective casing (24), into which the lock cylinder (20) is fitted.

9. Fuel tank according to any of the claims 1-8, characterized in that it further comprises a suction pipe (12) for discharging fuel out from the fuel tank, the suction pipe (12) being arranged at least partly inside the protective casing (24).

10. Fuel tank according to any of the claims 1-9, characterized in that the wall (26), filling pipe (10), protective cover (16) and protective casing (24) are made of steel.
